(19) United States
(12) Patent Application Publication
(10) Pub. No.: US 2013/0270037 A1
(43) Pub. Date: Oct. 17, 2013

(54) LADDER WITH ENHANCED STABILITY

(71) Applicant: Roberto Giuseppe Pensieri, Milano (IT)

(72) Inventor: Roberto Giuseppe Pensieri, Milano (IT)

(21) Appl. No.: 13/993,436

(22) PCT Filed: Oct. 18, 2011
(86) PCT No.: PCT/IB2011/054632

§ 371 Date: Jun. 12, 2013

(30) Foreign Application Priority Data
Dec. 21, 2010 (IT) MI2010A 002333

(51) Int. Cl. E06C 7/18

(52) U.S. Cl. CPC E06C 7/18
USPC 182/107

(57) ABSTRACT

A portable ladder, advantageously of the folding type, comprising a structure having steps, further comprises at least one vertical telescopic support prop with top and bottom ends which have feet for wedging the support prop between a bottom surface supporting the ladder on the ground and a surface above the ladder, so as to form wedged fixing systems which prevent the ladder from tipping over.

The present invention relates to a portable ladder, advantageously of the folding type. It is known that portable ladders may be dangerous owing to their intrinsic instability. Even just a slight loss of balance by a person climbing the ladder, in particular when reaching the upper steps, may result in a fall with the risk of serious injury. The likelihood of losing one's balance is moreover increased by the fact that the ladder in general cannot provide stable gripping points for the hands and, in order to overcome this problem, leaning against parts or zones surrounding the ladder (e.g. walls or the like) may cause the ladder to tip over as a result of the reactive forces.

In the prior art solutions have been proposed in an attempt to solve the problem. Often, however, the structure of ladders with an enhanced stability is excessively heavy or difficult and complicated to unfold, resulting in the ladder being bulky also when in the folded-up position.

For example, ladders provided with movable auxiliary feet have been proposed in order to increase the supporting base of the ladder and make it difficult for the centre of gravity to move outside of the base. This makes the ladder more stable, but does not solve the problem of the risk of the user losing his/her balance. Moreover, the increase in the space needed on the ground to the support the ladder creates difficulty in positioning of the ladder, to the point of this being impossible in certain cases when the legs are extended in their correct position.

Ladders have also been proposed where a part is wedged between the top end of the ladder and the ceiling.

For example, DE202004007792 and DE202004008999 describe ladders with parts resting only against the ceiling, only on the ground, or with two separate supporting/bearing parts, i.e. one directed towards the ceiling and the other one towards the ground. The parts are connected to the ladder by means of a rotational pin.

With these solutions, however, the safety of the fixing system depends on the rigidity of the ladder. Especially in the case of light folding ladders, for example made of aluminium, the flexibility of the structure when under load may easily result in lowering, even only momentarily, of the part resting against the ceiling. Paradoxically, this solution therefore results in the ladder being even more dangerous, since the user relies on a fixing system which may fail suddenly without any warning. In this case, if the user, relying on the presence of the part resting against the ceiling, should at that moment lean out from the ladder, the ladder would become suddenly unstable and tip over with the risk of serious injury. In the case of two separate parts there may also be a misalignment which favours separation and sudden tipping.

The general object of the present invention is to overcome the abovementioned drawbacks by providing a ladder which is more stable and safer during use, while occupying a small amount of space, in particular in the area where it rests on the ground, as well as being easy to manoeuvre and position.

In view of this object the idea according to the invention is to provide a portable ladder comprising a structure with steps, characterized in that it comprises at least one vertical telescopic support prop with a top end and bottom end which have feet for wedging the support prop between a bottom surface supporting the ladder on the ground and a surface above the ladder, so as to form wedged fixing points which prevent the ladder from tipping over.

In order to illustrate more clearly the innovative principles of the present invention and its advantages compared to the prior art, an example of embodiment applying these principles will be described below, with the aid of the accompanying drawings. In the drawings:

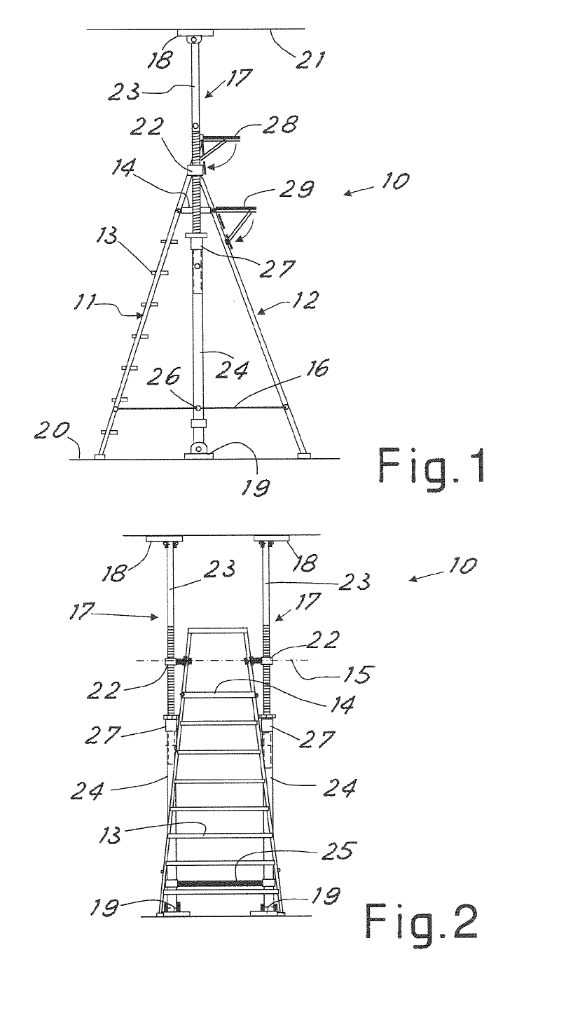

FIG. 1 shows a side view of a ladder according to the invention during use;

FIG. 2 shows a front view of the ladder according to FIG. 1;

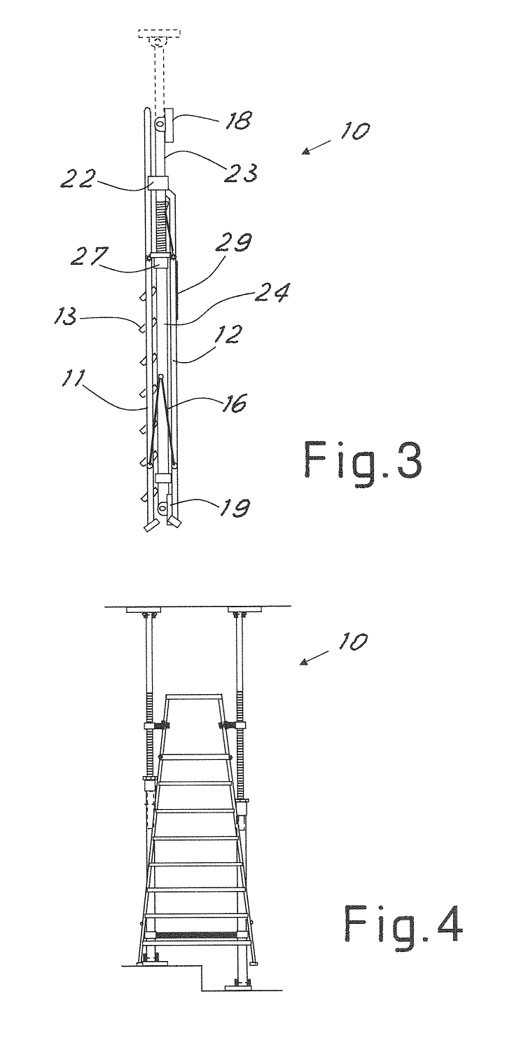

FIG. 3 shows a view of the ladder according to FIG. 1 in the folded condition;

FIG. 4 shows a view, similar to that of FIG. 2, but with the ladder in a different operating condition.

With reference to the figures, FIG. 1 shows a safety ladder denoted overall by 10 and designed according to the invention.

The ladder 10 comprises a foldable (or compass-like) structure with legs 11 and 12 and steps 13 leading to a top platform 14. The legs 11 and 12 are hinged along a transverse axis 15 so as to close up by means of a mechanism which is substantially known, with the platform 14 which folds upwards. In this way the legs of the ladder are movable between an operating condition where the ladder is open in the manner of an overturned V and a non-operating condition where the ladder is closed with the legs substantially parallel. Each leg is advantageously formed by a pair of side shoulders (resting at the bottom on the ground and at the top provided with the hinging system 15) and by connecting cross-pieces (which, in the case of the leg 11, may be formed at least partly by the said steps 13), according to a well-known ladder structure.

Cross-pieces 16, which are hinged or flexible, may be advantageously provided between the legs 11 and 12 which can be opened, so as to provide a further safety system preventing the hinged structure from opening fully also when subject to the load occurring during normal use of the ladder. For example, two cross-pieces 16 may be designed so as to be rigid with a central hinge 26.

The ladder also comprises at least one vertical support prop 17 (in the advantageous embodiment shown and described here the support props 17 are two in number and arranged parallel on either side of the folding structure).

The support prop 17 is telescopic and ends at the top and bottom in support feet, 18 and 19 respectively, which can be wedged between the floor 20 and the ceiling 21. Here “floor” and “ceiling” are understood as meaning, respectively, a bottom surface for supporting the ladder on the ground and a surface above the ladder and not necessarily a ceiling and a floor in a room.

The feet 18 and 19 are advantageously articulated both so as to adapt to slight inclinations of the supporting/bearing points relative to the axis of the support prop and so as to reduce the overall volume when the ladder is folded up.

Advantageously the support props are telescopically adjustable, with a top part 23 and a bottom part 24 which are slidable relative to each other and whose relative position can be adjusted axially via adjusting and releasable locking means 27, such that each support prop can be adjusted lengthwise depending on the distance existing between the floor and ceiling at the supporting/bearing points of the respective feet.

As can be seen more clearly in FIG. 2, the two support props 17 are arranged symmetrically on the sides of the folding structure so as to be arranged parallel to each and are fastened to the structure by means of two collars 22 which are fixed to the structure and which allow the top part 23 of the respective support prop to slide inside them. Advantageously the collars 22 are arranged close to the hinging axis 15 of the foldable structure of the ladder.

Advantageously, the top part 23 is telescopically retractable inside the bottom part 24 of the support prop.

A stiffening cross-piece 25 is advantageously present in the vicinity of the bottom end of the two support props. In particular, the cross-piece may be situated between the two bottom parts of the support props. This cross-piece 25, together with the top fastening system consisting of the collars 22, helps keep the two support props parallel to each other. Again advantageously, the cross-piece 25 may have ring-like ends so as to allow the sliding through-movement of the bottom parts of the support props. This allows heightwise adjustment of the base of each support prop.

Advantageously, the means 27 comprise respective internally threaded sleeves 27 which can be rotated axially on the top end of the bottom part 24 of the support prop so as to be screwed along a corresponding outer thread present along at least one section of the top part 23 of the support prop.

As an alternative to the adjusting screw system other known systems may be envisaged for adjusting a telescopic tubular structure, for example of the rack or similar type, for more rapid adjustment of the length during extension and/or retraction. These systems are well known per se and can be easily imagined by the person skilled in the art and will therefore not be further described or shown here.

As is clear from the figures, when the ladder is positioned for use, it is merely required to lengthen the telescopic support props so as to wedge them firmly between floor and ceiling. The stability of the wedged arrangement does not depend on the structure of the folding ladder part and therefore this structure may be a relatively light structure, for example made of aluminium, comparable to that of conventional folding ladders.

The telescopic support props, in particular if designed so as to be tubular with a circular cross-section, have instead a high axial rigidity, even though made of a light material, such as aluminium. However, they may also be made of other materials, such as steel, suitable for this purpose.

The support props, in addition to providing the ladder with stability, may also be used as convenient and stable handrails for climbing up the ladder to the top platform, thus ensuring a further degree of safety for the user when using the ladder.

As can be clearly seen in FIG. 1, owing to the stability of the ladder according to the invention, further auxiliary foldable platforms 28 and 29 may also be provided.

FIG. 3 shows the ladder in the folded condition. In this condition, the two legs 11 and 12 are brought into a position close to each other with the two support props remaining in between them. As can be seen in the figures, the support props slide inside the respective collars and are shortened so as to remain within the length of the ladder legs. The ladder therefore assumes an overall volume which is comparable to that of a normal folding ladder. Sliding of the support props with respect to the bottom cross-piece and the collars 22 may allow easy axial positioning of the support props both when the ladder is closed and so as to allow adjustment to height differences between ceiling and floor.

At this point it is clear how the predefined objects have been achieved, providing a ladder which is very stable during use and allows easy and stable gripping by the user also when climbing up the ladder to the top platform. Moreover, the ladder according to the invention may also be used in confined spaces and can be easily adapted to supporting surfaces which are not flat. For example, FIG. 4 shows schematically how the ladder may be used with total safety also on steps where the horizontal surface would be too small to allow use of a conventional ladder. The support props are axially rigid between ceiling and floor and any sudden misalignment or separation is prevented. Obviously, the above description of an embodiment applying the innovative principles of the present invention is provided by way of example of these innovative principles and must therefore not be regarded as limiting the scope of the rights claimed herein. For example, although an advantageously folding type structure has been described, if required the rear part of the ladder (namely the leg 12) may also not be present and the part 11 may be entirely supported by the support props 17. The collars 22 may also be designed with clamps for fixing to the folding structure so as to allow removal of the support props from the ladder when they are not required or fixing of the support props to a conventional ladder. Moreover, the ladder may be designed so as to have points which are completely outside of the profile of the legs. In this way the width of the ladder is greater, but the ladder may be used, for example, also without opening the two legs, but only inclining them on the side where the steps are situated, with the vertical support props ensuring stable positioning on the ground.

The support props 17 may be also be connected at the bottom to the legs of the ladders by means of suitable hinged connections so as to keep them, symmetrically relative to the centre, between the legs 11 during the opening/closing movement of the ladder. This hinged connection may also be advantageously achieved by means of the cross-piece 25, for example connecting it to the hinging point 26 of the hinged cross-pieces 16 on the two sides of the ladder. It is also possible to consider using transverse pins to lock the sliding movement of the bottom parts of the support props along the cross-piece 25 so as to prevent, when required, downwards sliding of the support props beyond the bottom of the ladder. This may be useful, for example, when the ladder is in its folded condition. In this way, when the ladder is in its closed or transportation condition, the top section of the support prop is locked towards the bottom by the corresponding collar 22, while the bottom part of the support prop is locked in position by the transverse pin and, at the top, by the sleeves 27.

1. Portable ladder comprising a structure having steps and at least one additional vertical axially rigid telescopic support prop fastened to the structure, the support prop having top and bottom ends each of which have feet for wedging the support prop between a bottom surface supporting the ladder on the ground and a surface above the ladder, so as to form wedged fixing systems which prevent the ladder from tipping over.

2. Portable ladder according to claim 1, wherein the structure is a folding structure, with legs which are hinged at a top of the structure along a transverse axis so as to be movable between an operating condition where the ladder is open in form of an overturned V and a non-operating condition where the ladder is closed with the legs substantially parallel.

3. Portable ladder according to claim 1, wherein the at least one support prop involves two support props arranged parallel on opposite sides of the structure with steps.

4. Portable ladder according to claim 2, wherein the at least one support prop involves two support props arranged parallel on opposite sides of the structure, wherein the support props are fastened to the structure close to the transverse axis and are fastened together by means of a cross-piece which is close to bottom ends of the support props.

5. Portable ladder according to claim 3, wherein the two support props are fastened to the structure at least by means of respective collars for allowing the support props to slide with respect to the structure.

6. Portable ladder according to claim 1, wherein the at least one support prop comprises a top part and a bottom part which are slidable relative to each other and adjustable axially with respect to each other via adjusting and releasable locking means.

7. Portable ladder according to claim 6, wherein the adjusting and releasable locking means comprise an internally threaded ring which is screwed onto an externally threaded section of the top part of the respective support prop.

8. Portable ladder according to claim 1, wherein the feet at the top and bottom ends of the support prop are hinged so as to be inclinable with respect to the support prop.

9. Portable ladder according to claim 1, further comprising foldable auxiliary platforms.

10. Portable ladder according to claim 4, wherein each of the two support props has a bottom part which is slidable axially with respect to the interconnecting cross-piece so as to allow staggered height adjustment of the feet of each of the support props.

11. Portable ladder according to claim 3 wherein the two support props are fastened close to a transverse axis of the structure and are fastened together by means of a cross-piece which is close to bottom ends of the support props, wherein each of the support props has a bottom part which is slidable axially with respect to the interconnecting cross-piece so as to allow staggered height adjustment of the feet of each of the support props.
